(19) United States
(12) Patent Application Publication
(10) Pub. No.: US 2025/0115367 A1
(43) Pub. Date: Apr. 10, 2025

(54) INTERNAL FLOW DIVERSION FLANGE

(71) Applicant: Advanced Flow Solutions Inc., Oklahoma City, OK (US)

(72) Inventors: Khushal S. DIDDEE, Oklahoma City, OK (US); Michael FALK, Lake Geneva, WI (US)

(73) Assignee: Advanced Flow Solutions Inc., Oklahoma City, OK (US)

(21) Appl. No.: 18/908,358

(22) Filed: Oct. 7, 2024

Related U.S. Application Data
(60) Provisional application No. 63/588,145, filed on Oct. 5, 2023.

(51) Int. Cl. B64D 37/00; G01N 9/32

(52) U.S. Cl. CPC B64D 37/005; G01N 9/32

(57) ABSTRACT

A fluid transfer system component for internally measuring fluid density in real- time. The component may be a flange comprising a base having a first face and a second face, a primary fluid passageway extending through the base from the first face to the second face, a secondary fluid passageway extending through the base from the first face to the second face, and an outside wall, a portion of which is configured to operably engage with a measuring device and comprises a third opening. The primary fluid passageway may have a non-circular cross-section allowing the secondary fluid passageway to be parallel to the primary fluid passageway. The third opening may be in fluid communication with the secondary fluid passageway allowing the measurement device to measure fluid data such as fluid density via the secondary fluid passageway.

### CROSS-REFERENCE TO RELATED APPLICATIONS

This application claims priority to U.S. Provisional Patent Application Ser. No. 63/588,145, entitled INTERNAL FLOW DIVERSION FLANGE, filed Oct. 5, 2023, which is incorporated herein by reference.

### BACKGROUND

Flanges can be used in fluid transfer systems such as piping or pumping systems to support or strengthen the system or to connect various components (e.g., pipes, pumps, elbows, measurement apparatuses, etc.) to the system. Often, when transferring fluid, such as fuels, from a storage vessel to a receiving vehicle or container, a metering apparatus is used to identify the amount of liquid transferred and its characteristics in order to maintain appropriate records. It is common in aviation fueling applications for operators of aircraft to consider the weight or mass of fuel contained onboard the aircraft, before considering the volume of fuel, due to a need to determine a total variable load on an aircraft (people, cargo, supplies, fuel, etc.), which can dictate whether an aircraft is appropriately loaded prior to takeoff. Aviation operator's fuel requests are often given in the local mass or weight unit of measure (e.g., kg, lbs., etc.) based on calculations of fuel (e.g., energy on board) required to safely fly to their destination. To accurately supply the operator's fuel request, the fuel's specific gravity or density is measured and used to calculate the volume equivalent of the requested fuel weight.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more devices and/or systems are disclosed for providing improved density measurements of fluid within a fluid transfer system. Density measurement improvements including increased accuracy and real-time data collection improve management of fueling, and help provide accurate fueling, which can reduce fuel consumption and carbon emissions (e.g., and save money). As an example, a fuel delivery system may utilize an internal flow diversion flange to measure fuel density through an internal bypass while mitigating any negative impact to the overall performance of the delivery system and eliminating external flow diversion, thereby allowing for accurate, real-time density measurements. The density can be used to calculate fuel volume or weight based on the amount of fuel transferred in real time. In another implementation, an internal flow diversion flange may be implemented with other fluid sensors or fluid diversion methodologies required to effectively sample fluids in a flow system.

In an implementation, a flange may comprise a base comprising a first face and a second face, a primary fluid passageway extending through the base from the first face to the second face, a secondary fluid passageway extending through the base from the first face to the second face, and an outside wall, a portion of which may be configured to operably engage with a measuring device. The first face may comprise a first opening and the second face may comprise a second opening, the first and second openings defining a flow region of the base. The primary fluid passageway may be disposed within the flow region of the base. The secondary fluid passageway may be disposed within the within the flow region of the base at a periphery of the primary fluid passageway. The portion of the outside wall may be configured to engage with the measuring device and may comprise a third opening in fluid communication with the secondary fluid passageway.

In another implementation, the primary fluid passageway may have a cross section being a truncated circle.

In yet another implementation, the portion of the outside wall may be configured to engage with the measuring device and may further comprise a recessed portion configured to receive the measuring device. The third opening may be located within the recessed portion and may fluidly communicate the recessed portion with the secondary fluid passageway.

In a further implementation, the recessed portion may further comprise a plurality of bores, the respective bores sized and shaped to receive a fastener.

In another implementation, the first opening may comprise a channel sized and shaped to receive a gasket or seal, and the second opening may comprise a channel sized and shaped to receive a gasket or seal.

In yet another implementation, the first opening of the first face may comprise a groove that extends outward from the first face, and the second opening of the second face may comprise a groove that extends outward from the second face.

In a further implementation, the base may comprise one or more bores that extend between the first face and second face, and the one or more bores may be respectively sized and shaped to receive a fastener.

In another implementation, the primary fluid passageway may further comprise an inner surface comprising at least one aperture communicating the primary fluid passageway with the outside surface of the base.

In yet another implementation, the flange may further comprise a sampling mechanism and wherein the at least one aperture may be configured to receive the sampling mechanism.

In a further implementation, the flange may further comprise at least one temperature sensor and at least one thermowell, wherein the at least one aperture may be configured to receive the at least one temperature sensor and the at least one thermowell.

In another implementation, the flange may further comprise at least one flow adjusting component disposed in the secondary fluid passageway, and the flow adjusting component may be configured to alter flow characteristics of a fluid traversing the secondary passageway.

In yet another implementation, the at least one flow adjusting component may be a bleeder screw and the secondary fluid passageway may be configured to securedly receive the at least one bleeder screw.

In a further implementation, a first flow adjusting component may be disposed in the secondary fluid passageway proximate the first face and a second flow adjusting component may be disposed in the secondary fluid passageway proximate the second face.

In another implementation, the flange may further comprise at least one seal.

In yet another implementation, the first and second openings may comprise an annular shape, and may be sized and shaped to operably engage with a fluid transfer system.

In a further implementation, the measuring device may be a densitometer.

In another implementation, a method for internally measuring the density of fluid flowing in a fluid transfer system may comprise providing a fluid transfer system, providing a flange within the fluid transfer system, providing a fluid flow through the flange, and measuring the density of the fluid flowing through the flange. Wherein the flange may comprise a base which may comprise a first face and a second face, a primary fluid passageway extending through the base from the first face to the second face, a secondary fluid passageway extending through the base from the first face to the second face, and an outside wall, a portion of which may comprise a recessed portion for receiving a densitometer and a third opening therein. The first face may comprise a first opening and the second face may comprise a second opening, wherein the first and second openings may define a flow region of the base. The primary fluid passageway may be disposed within the flow region of the base. The secondary fluid passageway may be disposed within the flow region of the base at a periphery of the primary fluid passageway. The portion of the outside wall may be configured to engage with the densitometer and may comprise a third opening fluidly communicating the recessed portion with the secondary fluid passageway. Wherein fluid may flow through the flange such that a first portion of the fluid may flow through the primary fluid passageway and a second portion of the fluid may flow through the secondary fluid passageway, and the density of the fluid may be measured within the second fluid passageway via the densitometer.

In yet another implementation, the method may further comprise providing at least one flow adjusting component in the secondary fluid passageway, and adjusting the at least one flow adjusting component to control the fluid flow through the secondary fluid passageway.

In a further implementation, the method may further comprise providing a sampling mechanism in an aperture of an inner surface of the primary fluid passageway, the aperture communicating the primary fluid passageway with the outside surface of the base, and collecting a sample of the fluid flowing through the primary fluid passageway.

In another implementation, the method may further comprise providing at least one temperature sensor and at least one thermowell in an aperture of an inner surface of the primary fluid passageway, the aperture communicating the primary fluid passageway with the outside surface of the base, and measuring the temperature of the fluid flowing through the primary fluid passageway.

In yet another implementation, an aviation fueling system may comprise a flange for internally measuring the density of fuel flowing in the system. The flange may comprise a base comprising a first face and a second face, a primary fluid passageway extending through the base from the first face to the second face, a secondary fluid passageway extending through the base from the first face to the second face, and an outside wall, a portion of which may comprise a recessed portion for receiving a densitometer and a third opening therein. The first face may comprise a first opening and the second face may comprise a second opening, wherein the first and second openings may define a flow region of the base. The primary fluid passageway may be disposed within the flow region of the base and may comprise a cross-section being a truncated circle. The secondary fluid passageway may be disposed within the flow region of the base at a periphery of the primary fluid passageway. The third opening may fluidly communicate the recessed portion with the secondary fluid passageway.

The densitometer may be configured to measure the density of fuel flowing through the secondary fluid passageway.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a front perspective view of an exemplary flange.

FIG. 2 is a rear perspective view of the flange.

FIG. 3 is a front view of the flange.

FIG. 4 is a rear view of the flange.

FIG. 5 is a left side view of the flange.

FIG. 6 is a right side view of the flange.

FIG. 7 is a top view of the flange.

FIG. 8 is a bottom view of the flange.

FIG. 9 is a front view of a cross-section of the flange.

FIG. 10 is a perspective view of the flange with an exemplary sensor.

FIG. 11 is a perspective view of the flange and sensor with exemplary flow adjusting components.

FIG. 12 is a perspective view of the flange and sensor showing an exemplary flow path.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

In the oil and gas industry, a densitometer is a sensor device often used to calculate the density or specific gravity of fluid flowing through a fluid transfer system. To achieve this, fluid from a primary flow line historically must be externally diverted through the densitometer at a prescribed flow velocity for the sensor to compute the fluid's density. This external diversion may provide delayed and therefore inaccurate measurements, in addition to being expensive and difficult to implement. The methods of integration of densitometers into fueling systems pose certain distinct challenges to effectively sample a precise amount of fluid flow to and through the densitometer, while attempting to reduce the negative impact to the overall performance of the flow system. Further, different fluid products have varying viscosities, resulting in the need for fluid passageways of varying sizes that allow flow from the primary flow line to the densitometer.

The principles of the present application relate to an internal flow diversion flange for a fluid transfer system, such as a fueling system, and thus will be described below in this context. It will be appreciated that the principles of the application may be applicable to flanges for other flow systems, such as oil, water, steam, gasses, etc.

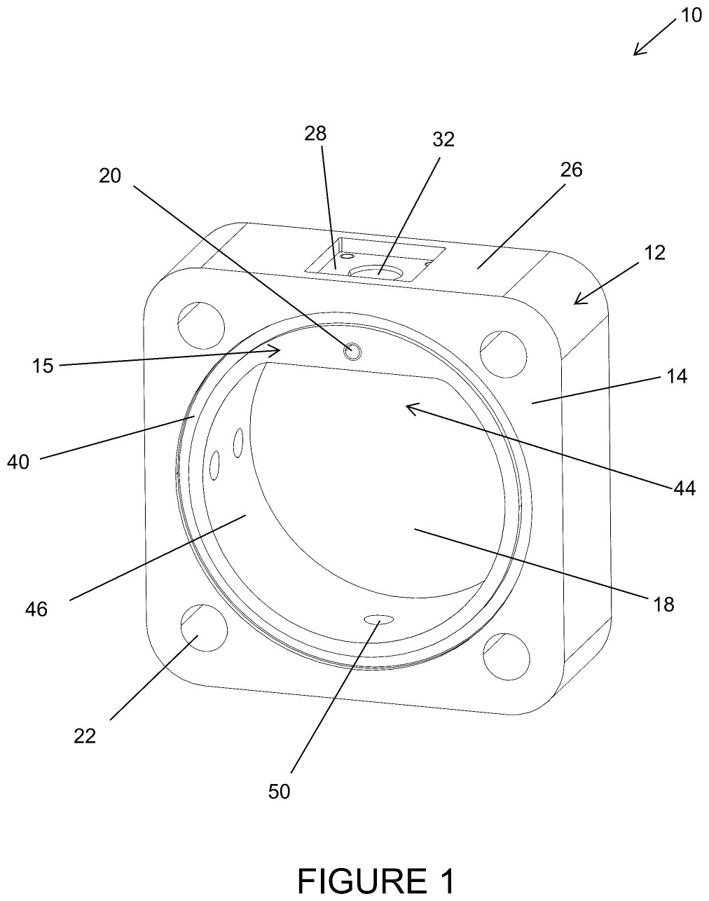

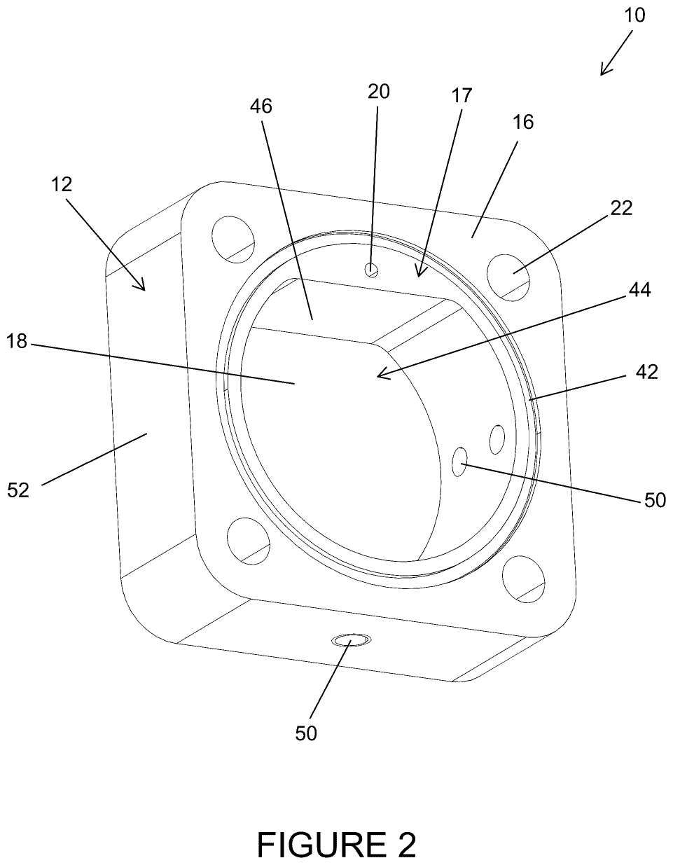

Turning initially to FIGS. 1 and 2, a flange is shown generally at reference numeral 10. The flange 10 may be configured to be implemented in a fluid transfer system, such as a fuel system, to support or strengthen the system or to connect various components such as pipes and measurement devices. The flange 10 may include a base 12 having a first face 14 and second face 16, a primary fluid passageway 18, a secondary fluid passageway 20, a plurality of bores 22 each sized and shaped to receive a fastener, and an outside wall 52, a portion 26 of which is configured to operably engage with a measuring device 30. The flange 10 may be made of any suitable material capable of supporting fluid system components (e.g., piping, pumps, measurement devices), resistant to corrosion and the corruption of passing fluids, and capable of being easily manufactured. For example, the flange 10 may be made of a suitable metal, such as stainless steel, alloy steel, carbon steel, aluminum, molybdenum, nickel, etc., or a suitable plastic, such as synthetic polymer, etc.

The base 12 of the flange 10 may be any shape suitable to support or strengthen the system or to connect various components such as pipes and measurement devices. In an implementation, for example, the base 12 of the flange 10 may be a rectangular prism having a substantially square cross section having rounded corners. It will be appreciated that the base 12 of the flange 10 may be a cylinder having a circular cross section, a rectangular prism having a rectangular cross section, etc.

To secure the flange 10 to a fluid transfer system or a component of the same, the base 12 of the flange 10 may include a plurality of bores 22 each sized and shaped to receive a fastener. The plurality of bores 22 may be further configured to align with a plurality of complement bores of a component to which the flange 10 may be connected. In an implementation, for example, the base 12 of the flange 10 may be a rectangular prism having a substantially square cross-section having rounded corners. The base may have one of four bores 22 disposed proximate each corner of the substantially square cross-section, the bores 22 being configured to align with a plurality of bores on an identical flange such that the flanges may be coupled via fasteners, such as nut-and-bolt systems, inserted through the bores. It will be appreciated that the flange 10 may be connected to a fluid transfer system or a component of the same via any suitable means, for example, welds, nut-and-bolt systems, gaskets, combinations of the same, etc.

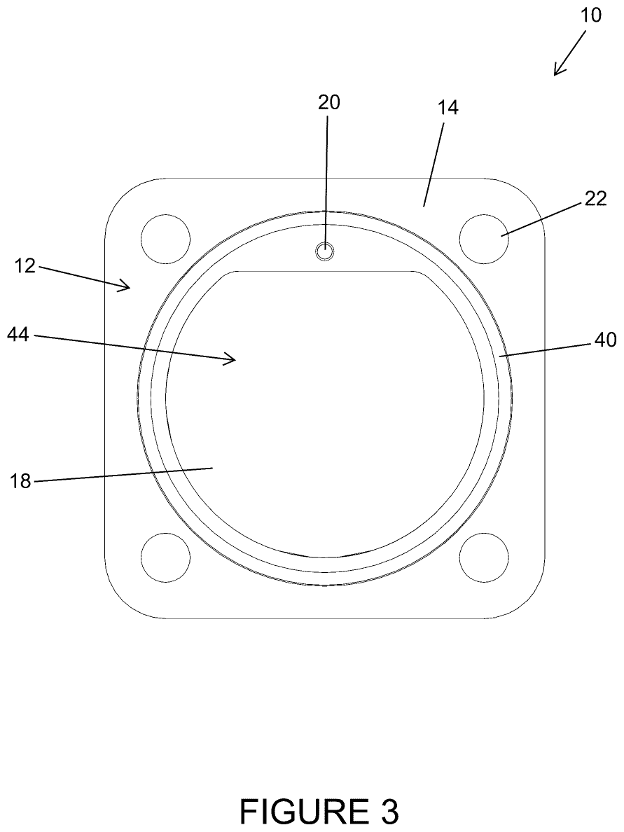

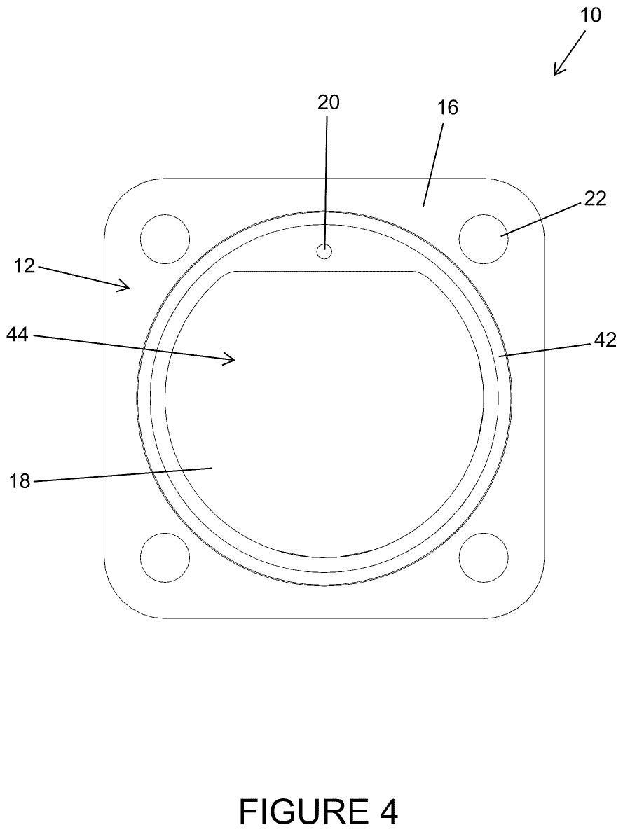

Turning additionally to FIGS. 3 and 4, the first face 14 of the base 12 may include a first opening 15 comprising an annular shape and a channel 40, the channel 40 extending inward toward the second face 16. The second face 16 of the base 12 may include a second opening 17 comprising an annular shape and a channel 42, the channel 42 extending inward toward the first face 14. It will be appreciated that the channels 40, 42 may be configured to receive another component. For example, the channels 40, 42 may be substantially circular and configured to receive an end of a pipe, a gasket or seal such as an O-ring, another flange, combinations of the same, etc. In an implementation, for example, the channel 40 of the first face 14 may be configured to receive an O-ring and an end of a pipe such that a seal is formed between the pipe end and the flange 10; the pipe end may then be welded to the flange 10 to secure the pipe to the flange 10. Alternatively, the channels 40, 42 may be raised portions or grooves extending outward away from the first and second faces, 14, 16 respectively.

The first and second openings 15, 17 of the first and second faces 14, 16 may be sized and shaped to operably engage with a fluid transfer system, thereby defining a flow region 44 of the base 12. In one implementation, the flow region 44 may be a region of the base 12 extending from a circular area on the first face 14 defined by the channel 40 of the first face 14 to a circular area on the second face 16 defined by the channel 42 of the second face 16.

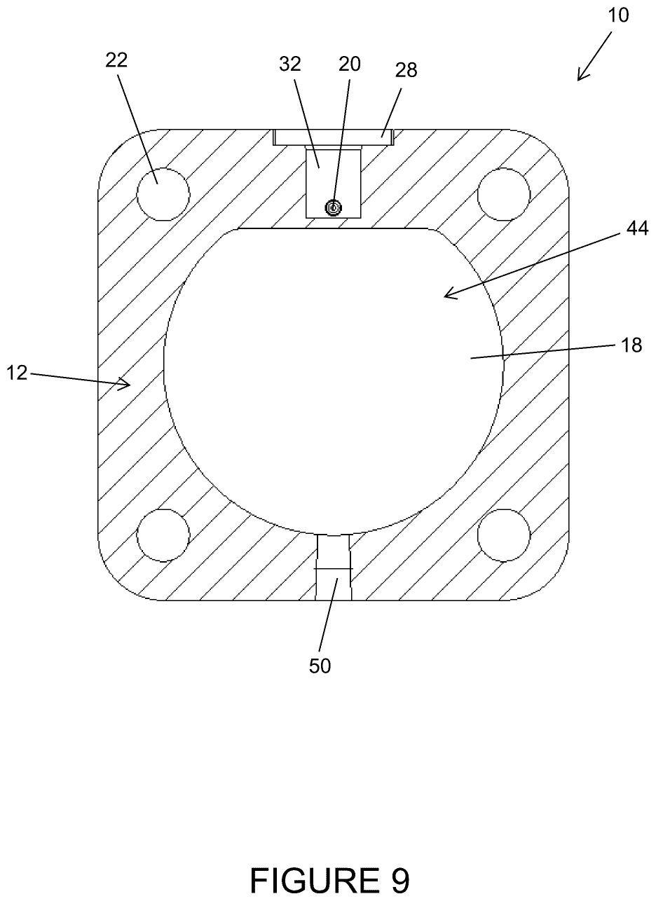

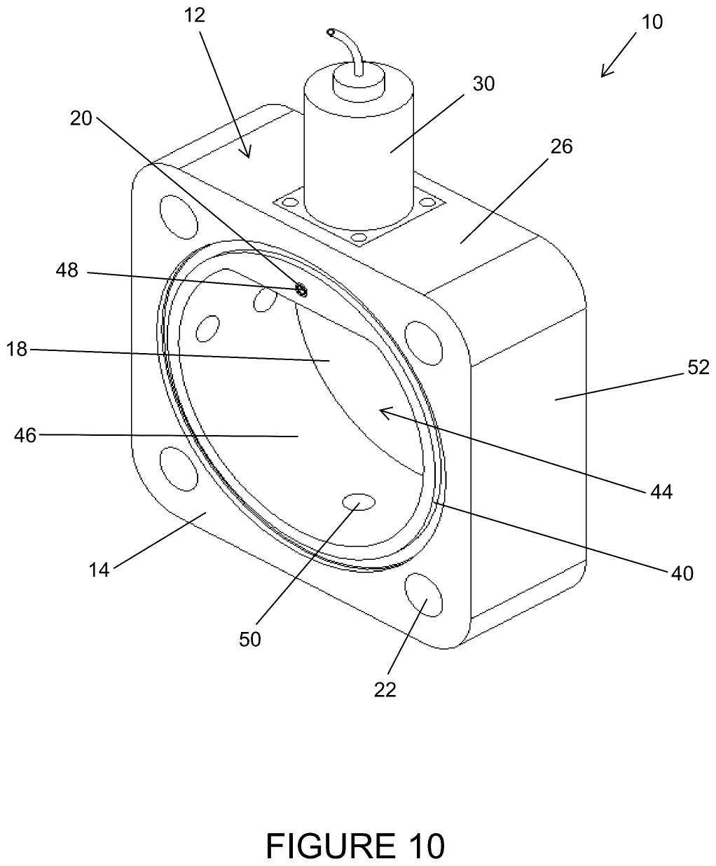

The primary fluid passageway 18 includes an inner surface 46 and may be disposed within the flow region 44 of the base 12 and extend through the base 12 from the first face 14 to the second face 16. As shown in FIG. 9, the cross-section of the primary fluid passageway 18 may be non-circular. For example, the cross-section of the primary fluid passageway 18 may be a truncated circle. In an implementation, the cross- section of the primary fluid passageway 18 is a truncated circle having a top of the cross-section being truncated. The primary fluid passageway 18 is configured to be in fluid communication with a fluid transfer system such that when the flange 10 is incorporated into a fluid transfer system, fluid may flow through the primary fluid passageway 18 without being subject to or causing significant turbulence or disruption to the flow.

The secondary fluid passageway 20 may be disposed within the flow region 44 of the base 12 at a periphery of the primary fluid passageway and extend through the base 12 from the first face 14 to the second face 16. The secondary fluid passageway 20 may have a cross-sectional area less than that of the primary fluid passageway 18. In an implementation wherein the cross-section of the primary fluid passageway 18 is a truncated circle having a top being truncated, the secondary fluid passageway 20 is positioned above the primary fluid passageway 18 and within the flow region 44 of the base 12 and runs parallel to the primary fluid passageway 18. By implementing a primary fluid passageway 18 having a non-circular cross-section and by disposing the primary fluid passageway 18 and the secondary fluid passageway 20 within the flow region 44 of the base 12, the secondary fluid passageway 20 can be configured to internally divert a portion of the fluid flow to a fluid passageway generally parallel to the primary fluid passageway 18.

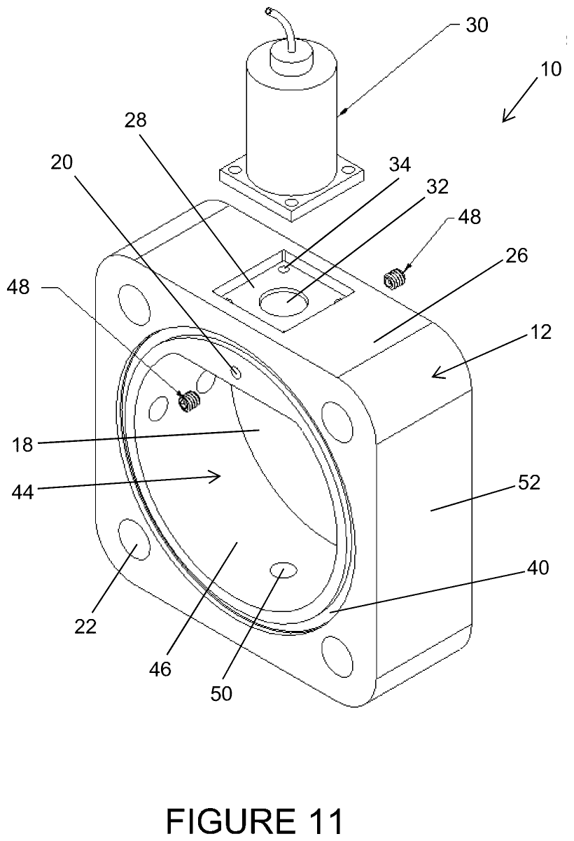

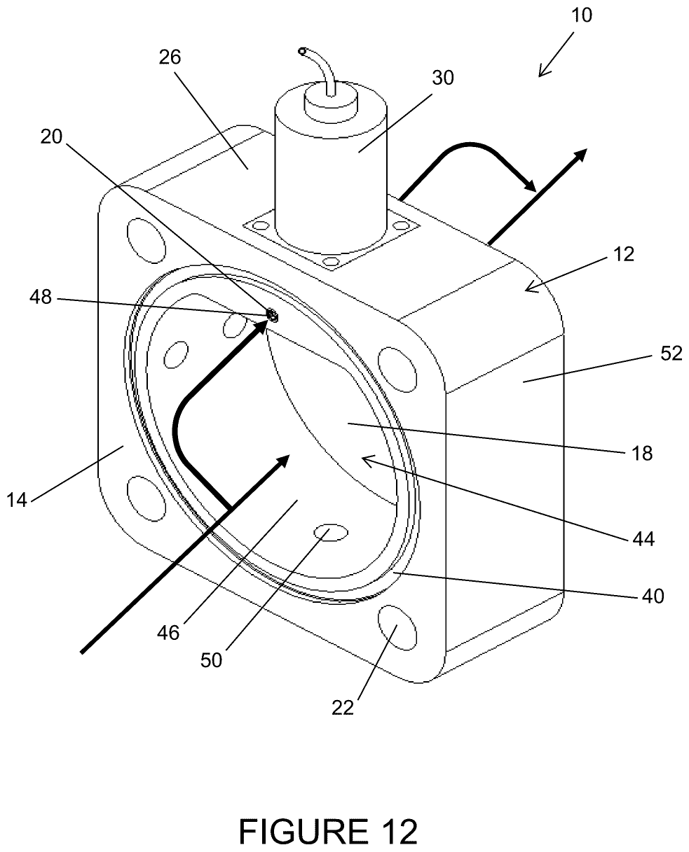

The secondary fluid passageway 20 may be drilled, threaded, or otherwise configured to allow for the insertion of flow adjusting components 48 (FIGS. 10-11), for example, bleeder screws, etc. By allowing for the insertion of flow adjusting components 48 into the secondary fluid passageway 20 at an end of the secondary fluid passageway 20 proximate the first face 14 and/or at an end of the secondary fluid passageway 20 proximate the second face 16, the flow velocity at which the fluid from the fluid transfer system passes through the secondary fluid passageway 20 can be controlled. Because the flow velocity can be controlled, different types of fluid having varying properties (e.g., viscosity) can be implemented in the fluid transfer system while maintaining a desired flow velocity through the secondary fluid passageway.

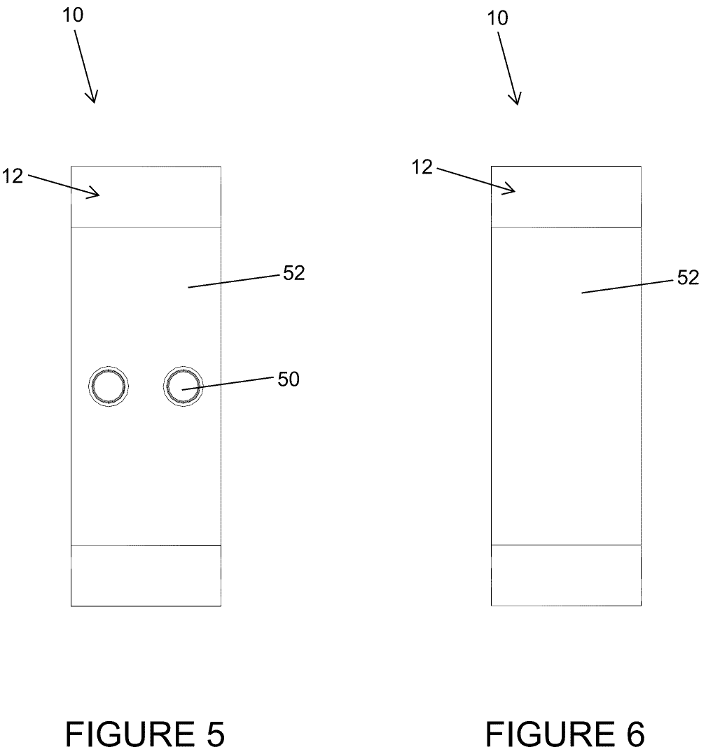

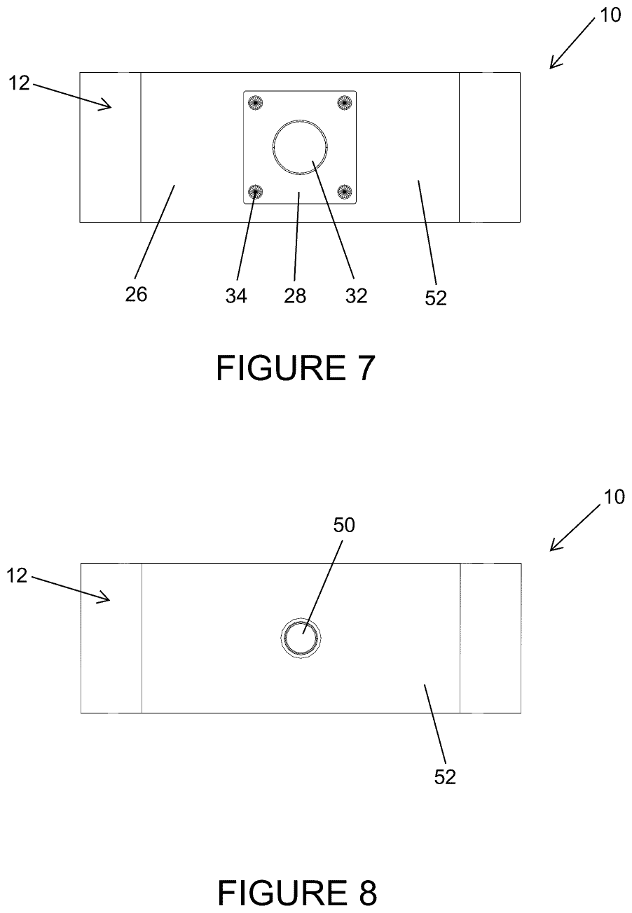

Turning additionally to FIGS. 5-8, the base may include at least one aperture 50 extending from an outside wall 52 of the base 12 to the inner surface 46 of the primary fluid passageway 18. The at least one aperture 50 may be configured to receive measurement devices for controlling and collecting data on the fluid flowing through the primary fluid passageway 18. For example, the at least one aperture 50 may be configured to receive a sampling tube from which product can be pulled at slower rates for examination, a thermowell for temperature compensation, a temperature sensor, etc.

Turning additionally to FIGS. 9-11, the portion 26 of the outside wall 52 which is configured to operably engage with a measuring device 30 may comprise a recessed portion 28 for receiving a measuring device 30. A plurality of bores 34 sized and shaped to receive a fastener may be disposed within the recessed portion 28 to secure the measuring device 30 within the recessed portion 28. A third opening 32 may also be disposed within the recessed portion 28 communicating the recessed portion 28 and/or portion 26 of the outside wall 52 with the secondary fluid passageway 20. In an implementation, the measuring device 30 received by and secured into the recessed portion 28 of the base 12 may be a densitometer configured to measure the density of the fluid flowing through the secondary fluid passageway 20. It will be appreciated that that the recessed portion 28 may be any shape configured to receive and secure the measuring device 30. In one implementation, for example, the recessed portion 28 may be substantially rectangular to receive a measuring device 30 having a substantially rectangular base, the plurality of bores 34 of the recessed portion 28 being disposed at each corner of the substantially rectangular recessed portion 28 and configured to align with a plurality of counterpart bores of the measuring device 30 and receive a plurality of fasteners. In another implementation, the portion 26 of the outside wall 52 may comprise a plurality of bores for securing the measuring device 30 thereto, and the measuring device 30 may be installed directly onto the portion 26 of the outside wall 52 of the base 12.

The portion 26 of the outside wall 52 of the base 12 includes a third opening 32 extending downward into the base 12 toward the secondary fluid passageway 20 such that the third opening 32 communicates the secondary fluid passageway 20 with the portion 26 of the outside wall 52 substantially without disrupting fluid flow through the secondary fluid passageway 20. The size and shape of the third opening 32 may be configured to allow the measuring device 30 to collect data from fluid flowing through the secondary fluid passageway 20. For example, the third opening 32 may be a substantially continuous cylinder configured to receive a measuring device 30 such as a densitometer having a substantially cylindrical flow rate sensor. In an implementation, the third opening 32 may be disposed within the recessed portion 28 of the portion 26 of the outside wall 52 of the base 12. For example, a measuring device 30 may be a densitometer received by and installed in the recessed portion 28, the densitometer having a flow meter portion disposed in the third opening 32. By installing the measuring device 30 onto the portion 26 of the outside wall 52 of the base 12 such that the measuring device 30 may be subject to the flow through the secondary fluid passageway 20, measurements of the fluid flow can be taken without the need for external tubing, mounting, or other associated external equipment. In an implementation wherein the measuring device 30 is a densitometer, a real-time density reading can be taken of the fluid flowing though the fluid transfer system without the need for an external bypass having a slipstream.

Turning now to FIG. 12, the flange 10 may be implemented into a fluid transfer system to internally divert fluid flow from the primary fluid passageway 18 to the secondary fluid passageway 20 to measure and record characteristics of the fluid. For example, the flange 10 may be implemented into an aviation fueling system. Here, the flange 10 may be situated between two components, for example, two pipes, a pipe and a second flange, a pipe and a pump, etc. Once implemented into the fueling system, fuel may flow toward the first face 14 of the base 12 of the flange 10. Upon reaching the first face 14, the fuel may flow through the primary fluid passageway 18. While flowing through the primary fluid passageway 18, samples of the fuel may be taken from at least one aperture 50 for subsequent external testing, and temperature sensors protected by thermowells implemented in at least one aperture 50 may record temperature data of the fuel. The fuel may then flow out of the primary fluid passageway 18 toward an aircraft for fueling. Simultaneously, a portion of the fuel that flows toward the first face 14 of the base 12 of the flange 10 may be diverted to flow through the secondary fluid passageway 20. The portion of fuel flowing through the secondary fluid passageway 20 may be subject to flow adjusting components 48 such as bleeder screws installed in the secondary fluid passageway 20 and a measuring device 30 such as a densitometer installed on a portion 26 of the outside wall 52 of the base 12 of the flange 10. The bleeder screws may control the flow velocity of the fuel to a prescribed flow velocity according to the type of fuel and densitometer settings. The densitometer may measure the density of the fuel in the fluid transfer system in real-time as the fuel passes through the secondary fluid passageway 20 and third opening 32. The portion of fuel flowing through the secondary fluid passageway 20 may then flow toward the second face 16 of the base 12 and exit the secondary fluid passageway 20 to rejoin the fuel flowing out of the primary fluid passageway 18 toward the aircraft for fueling.

In an implementation wherein the flange 10 is equipped with a densitometer and installed in a fueling system, the real-time fuel density measurement can be used in conjunction with a fluid flow measurement to accurately determine the mass of fuel provided to an aircraft during fueling. For example, the density of a substance is equal to the mass of the substance per unit volume of the substance (Density=Mass/Volume). Therefore, if the volume of the fuel is known, and the actual density of the fuel is known, the mass of the fuel can be accurately determined, such as by a pilot of the target fueling aircraft.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A flange comprising:
a base comprising a first face and a second face, a primary fluid passageway extending through the base from the first face to the second face, a secondary fluid passageway extending through the base from the first face to the second face, and an outside wall, a portion of which is configured to operably engage with a measuring device;
the first face comprising a first opening and the second face comprising a second opening, the first and second openings defining a flow region of the base;
the primary fluid passageway disposed within the flow region of the base;
the secondary fluid passageway disposed within the flow region of the base, at a periphery of the primary fluid passageway; and
the portion of the outside wall configured to engage with the measuring device comprising a third opening in fluid communication with the secondary fluid passageway.

2. The flange according to claim 1 wherein the primary fluid passageway has a cross section being a truncated circle.

3. The flange according to claim 1 wherein the portion of the outside wall configured to engage with the measuring device further comprises a recessed portion configured to receive the measuring device, the third opening being located within the recessed portion and fluidly communicating the recessed portion with the secondary fluid passageway.

4. The flange according to claim 3 wherein the recessed portion further comprises a plurality of bores, the respective bores sized and shaped to receive a fastener.

5. The flange according to claim 1 wherein the first opening comprises a channel sized and shaped to receive a gasket or seal, and the second opening comprises a channel sized and shaped to receive a gasket or seal.

6. The flange according to claim 1 wherein the first opening of the first face comprises a groove that extends outward from the first face, and the second opening of the second face comprises a groove that extends outward from the second face.

7. The flange according to claim 1 wherein the base comprises one or more bores that extend between the first face and second face, the one or more bores respectively sized and shaped to receive a fastener.

8. The flange according to claim 1 wherein the primary fluid passageway further comprises an inner surface comprising at least one aperture communicating the primary fluid passageway with the outside surface of the base.

9. The flange according to claim 8 further comprising a sampling mechanism and wherein the at least one aperture is configured to receive the sampling mechanism.

10. The flange according to claim 8 further comprising at least one temperature sensor and at least one thermowell and wherein the at least one aperture is configured to receive the at least one temperature sensor and the at least one thermowell.

11. The flange according to claim 1 further comprising at least one flow adjusting component disposed in the secondary fluid passageway, the flow adjusting component configured to alter flow characteristics of a fluid traversing the secondary passageway.

12. The flange according to claim 11 wherein the at least one flow adjusting component is a bleeder screw and the secondary fluid passageway is configured to securely receive the at least one bleeder screw.

13. The flange according to claim 11 wherein a first flow adjusting component is disposed in the secondary fluid passageway proximate the first face and a second flow adjusting component is disposed in the secondary fluid passageway proximate the second face.

14. The flange according to claim 1 wherein the first and second openings comprise an annular shape, and are sized and shaped to operably engage with a fluid transfer system.

15. The flange according to claim 1 wherein the measuring device is a densitometer.

16. A method for internally measuring the density of fluid flowing in a fluid transfer system comprising:
providing a fluid transfer system;
providing a flange within the fluid transfer system, the flange comprising:
a base comprising a first face and a second face, a primary fluid passageway extending through the base from the first face to the second face, a secondary fluid passageway extending through the base from the first face to the second face, and an outside wall, a portion of which comprises a recessed portion for receiving a densitometer and a third opening therein;
the first face comprising a first opening and the second face comprising a second opening, the first and second openings defining a flow region of the base;
the primary fluid passageway disposed within the flow region of the base;
the secondary fluid passageway disposed within the flow region of the base, at a periphery of the primary fluid passageway; and
the portion of the outside wall configured to engage with the densitometer and comprising a third opening fluidly communicating the recessed portion with the secondary fluid passageway;
providing a fluid flow through the flange such that a first portion of the fluid flows through the primary fluid passageway and a second portion of the fluid flows through the secondary fluid passageway; and
measuring the density of the fluid flowing through the second fluid passageway via the densitometer of the flange.

17. The method of claim 16 further comprising:
providing at least one flow adjusting component in the secondary fluid passageway; and
adjusting the at least one flow adjusting component to control the fluid flow through the secondary fluid passageway.

18. The method of claim 16 further comprising:
providing a sampling mechanism in an aperture of an inner surface of the primary fluid passageway, the aperture communicating the primary fluid passageway with the outside surface of the base; and
collecting a sample of the fluid flowing through the primary fluid passageway.

19. The method of claim 16 further comprising:
providing at least one temperature sensor and at least one thermowell in an aperture of an inner surface of the primary fluid passageway, the aperture communicating the primary fluid passageway with the outside surface of the base; and
measuring the temperature of the fluid flowing through the primary fluid passageway.

20. An aviation fueling system comprising a flange for internally measuring the density of fuel flowing in the system, the flange comprising:
a base comprising a first face and a second face, a primary fluid passageway extending through the base from the first face to the second face, a secondary fluid passageway extending through the base from the first face to the second face, and an outside wall, a portion of which comprises a recessed portion for receiving a densitometer and a third opening therein;
the first face comprising a first opening and the second face comprising a second opening, the first and second openings defining a flow region of the base;
the primary fluid passageway disposed within the flow region of the base and having a cross-section being a truncated circle;
the secondary fluid passageway disposed within the within the flow region of the base, at a periphery of the primary fluid passageway; and
the third opening fluidly communicating the recessed portion with the secondary fluid passageway,
wherein the densitometer is configured to measure the density of fuel flowing through the secondary fluid passageway.
